(19) United States
(12) Patent Application Publication
(10) Pub. No.: US 2026/0050778 A1
(43) Pub. Date: Feb. 19, 2026

(54) MEMORY DEVICE FOR ACCELERATING NEURAL NETWORK, OPERATING METHOD OF THE MEMORY DEVICE, AND ELECTRONIC DEVICE INCLUDING THE MEMORY DEVICE

(71) Applicant: SAMSUNG ELECTRONICS CO., LTD., Suwon-si (KR)

(72) Inventors: Jaehoon Kim, Suwon-si (KR); Jinsoak Kim, Suwon-si (KR)

(21) Appl. No.: 19/179,854

(22) Filed: Apr. 15, 2025

(30) Foreign Application Priority Data
Aug. 19, 2024 (KR) 10-2024-0110768

(51) Int. Cl. G06N 3/063; G06N 3/082; G06N 3/084

(52) U.S. Cl. CPC G06N 3/063; G06N 3/082; G06N 3/084

(57) ABSTRACT

A memory device is configured to perform neural network learning, the memory device including a first dedicated memory corresponding to a first link included in a neural network and configured to store a first forward propagation weight and at least one first candidate weight for the first link, and a first processing element (PE) configured to perform a multiplication operation between an input and the first forward propagation weight stored in the first dedicated memory, for the first link, in which the first forward propagation weight stored in the first dedicated memory is configured to be updated with one of the at least one first candidate weight after the multiplication operation for the first link corresponding to the first dedicated memory.

### CROSS-REFERENCE TO RELATED APPLICATIONS

This application claims priority under 35 U.S.C. § 119 to Korean Patent Application No. 10-2024-0110768, filed in the Korean Intellectual Property Office on Aug. 19, 2024, the disclosure of which is incorporated by reference herein in its entirety.

### BACKGROUND

Applications such as high-performance and/or graphics algorithms are data-intensive and compute-intensive. Machine learning applications, such as neural networks, may include a large number of operations including a large amount of operations and memory requirements. Machine learning applications require a computing system with large operational and memory capabilities to more accurately train or learn different data sets.

A neural network may include a plurality of layers. To obtain more accurate results, the number of layers included in neural networks is increasing, and the time elapsed for operations may increase due to the increased amount of operations. To perform forward propagation and back propagation for training and/or deriving results of a neural network, each of the plurality of layers needs to receive a result of an operation in a previous layer. Accordingly, a processing device may not be used efficiently, and the time elapsed for neural network operations may increase. Accordingly, there is a demand to reduce the time elapsed for neural network operations by efficiently using processing devices.

### SUMMARY

In general, in some aspects, the present disclosure is directed toward a memory device configured to reduce the time elapsed for a neural network operation and including a plurality of dedicated memories configured to store weights respectively corresponding to a plurality of links included in a neural network, a method of operating the memory device, and an electronic device including the memory device.

According to some implementations, the present disclosure is directed to a memory device configured to perform neural network learning, the memory device including a first dedicated memory corresponding to a first link included in a neural network and configured to store a first forward propagation weight and at least one first candidate weight for the first link, and a first processing element (PE) configured to perform a multiplication operation between an input and the first forward propagation weight stored in the first dedicated memory, for the first link, wherein the first forward propagation weight stored in the first dedicated memory is configured to be updated with one of the at least one first candidate weights after the multiplication operation for the first link corresponding to the first dedicated memory.

According to some implementations, the present disclosure is directed to an operating method of a memory device, the method including performing a first operation on a first link included in a neural network based on a first forward propagation weight from among a plurality of weights stored in a first dedicated memory, after the first operation, updating weights other than the first forward propagation weights from among the plurality of weights stored in the first dedicated memory to first forward propagation weights, performing a second operation on a second link included in the neural network based on a second forward propagation weight from among a plurality of weights stored in a second dedicated memory and a result of the first operation, after the second operation, updating weights other than the second forward propagation weights from among the plurality of weights stored in the second dedicated memory to second forward propagation weights, generating a training weight for the second link based on a result of the second operation and storing the training weight for the second link as a second candidate weight in the second dedicated memory, and generating a training weight for the first link based on the training weight for the second link and storing the training weight for the first link as a first candidate weight in the first dedicated memory.

According to some implementations, the present disclosure is directed to a memory device configured to perform neural network learning, the memory device including a memory including a plurality of dedicated memory regions corresponding to a plurality of links included in a neural network, respectively, and a processor configured to perform an operation needed for training the neural network, wherein the plurality of dedicated memory regions are configured to store a plurality of weights for corresponding links, respectively, the plurality of dedicated memory regions are logically separated from one another, and the processor is further configured to perform the operation based on one of a plurality of weights respectively stored in the plurality of dedicated memory regions and to delete a weight used in the operation from the plurality of dedicated memory regions.

### BRIEF DESCRIPTION OF THE DRAWINGS

Example implementations will be more clearly understood from the following detailed description, taken in conjunction with the accompanying diagrams.

FIG. 1 is a diagram illustrating an example of a system including a memory device that performs internal processing operations according to some implementations.

FIG. 2 is a block diagram showing an example of a memory device according to some implementations.

FIG. 3 is a block diagram for illustrating an example of a neural network according to some implementations.

FIG. 4 is a diagram for illustrating examples of a neural network and weights corresponding to links included in the neural network according to some implementations.

FIGS. 5A to 5H are diagrams for illustrating an example operation of a neural network according to some implementations.

FIG. 6 is a block diagram for illustrating an examples of an electronic device according to some implementations.

FIG. 7 is a block diagram for illustrating an example of an electronic device according to some implementations.

FIG. 8 is a flowchart of an example of an operating method of a memory device according to some implementations.

FIG. 9 is a block diagram of an example of a system for describing an electronic device including a memory device according to some implementations.

### DETAILED DESCRIPTION

Hereinafter, example implementations will be explained in details with reference to the accompanying drawings.

Processing elements (PE) described herein may include processing units, such as neural processing units (NPU), central processing units (CPU), digital signal processors (DSP), graphic processing units (GPU), encryption processing units, physics processing units, machine learning processing units, etc., or logic circuits.

PEs may include various operational layers that perform processing-in-memory (PIM) operations. A first (e.g., lowest) level in an operational layer may include bit vector operations (e.g., fundamental logical operations, which may be referred to as “primitive” operations). A second (e.g., intermediate) level in the operational layer may include compound operations including a plurality of bit vector operations. For example, the compound operations may include mathematical operations such as addition, multiplication, etc., which may include plurality of logical ANDs, ORs, XORs, shifts, etc. A third (e.g., top) level in the operational layer may include control flow operations (e.g., looping, branching, etc.) associated with program execution that involve performing processing using PEs 510. However, the above description is intended to help understanding of a PE, and a PE according to the inventive concept is not limited thereto.

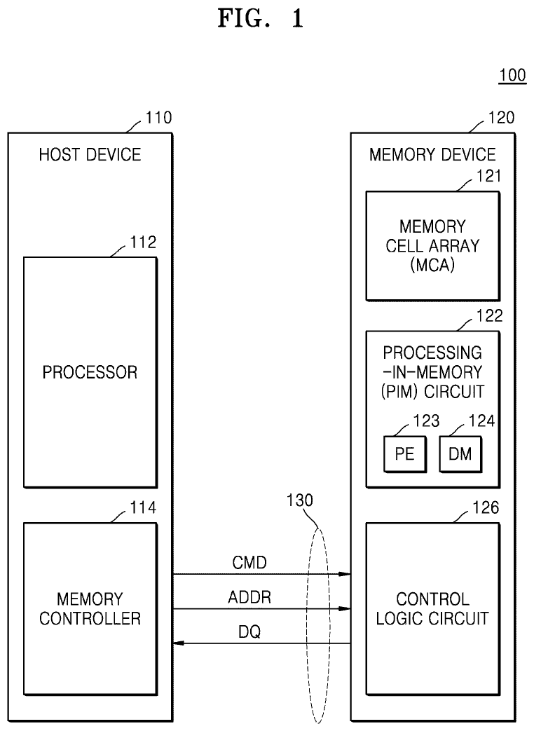

FIG. 1 is a diagram for illustrating an example of a system including a memory device that performs an internal processing operation according to some implementations. In FIG. 1, a system 100 may be configured to execute applications for high-performance computing, graphics operations, etc. or applications for learning systems, such as deep neural networks. These applications need high computational and memory capabilities to execute jobs or tasks cooperatively in a parallel fashion, train different data sets, and learn with high accuracy, wherein power efficiency and low latency are important.

The system 100 may include a host device 110 and a memory device 120. The host device 110 may be used to solve an overall job or task through a parallel processing approach in which the overall job or task is divided into smaller jobs that are executed in parallel by a large number of computing entities (e.g., processors 112, cores in the processors 112, and a processing-in-memory (PIM) circuit 122).

The host device 110 may be communicatively connected to the memory device 120 via a bus 130. The host device 110 may be, for example, a computing system, such as a computer, a laptop computer, a server, a workstation, a portable communication terminal, a personal digital assistant (PDA), a portable multimedia player (PMP), a smartphone, and a wearable device. In some implementations, the host device 110 may be one of components included in a computing system, e.g., a graphics card.

The host device 110 may include a processor(s) 112 for performing general computer operations in the system 100 and a memory controller 114 for managing data transmission/reception to/from the memory device 120. A processor 112 is a primary component of the system 100 that processes and manages instructions and is mainly responsible for executing an operating system and applications. Also, the processor 112 may enable a workload to be distributed across a plurality of computing entities to be processed in parallel to solve a complex job or task. The processor 112 may include a processing unit such as an NPU, a CPU, a DSP, a GPU, an encryption processing unit, a physical processing unit, a machine learning processing unit, etc.

The processor 112 may improve efficiency by distributing execution of various computational tasks, instructions, or kernels to other processors or offloading them to the memory device 120. A kernel is defined as one or more instructions that are grouped together to execute a task or definable sub-task. The PIM circuit 122 of the memory device 120 may perform calculation processing by a kernel offloaded by the processor 112. Various types of calculation processing operations may be performed by the PIM circuit 122. For example, at least some of neural network operations in relation to artificial intelligence may be performed by the PIM circuit 122. For example, the processor 112 may control the memory device 120 via the memory controller 114, such that at least some of neural network operations may be performed by the PIM circuit 122.

The memory controller 114 may access the memory device 120 according to a memory request of the host device 110. The memory controller 114 may control a write operation or a read operation for the memory device 120 by providing a command CMD and an address ADDR to the memory device 120. Also, data DQ to be written and read data DQ may be transmitted and received between the memory controller 114 and the memory device 120. Such a memory access operation may be performed through the bus 130 between the memory controller 114 and the memory device 120.

The bus 130 may operate in the PIM specifications and/or the high bandwidth memory (HBM) specifications under the control of the host device 110 (e.g., the memory controller 114). For simplicity of the drawings, it is illustrated that command/address signal lines and data lines are single lines between the memory controller 114 and the memory device 120, but the command/address signal lines and the data lines may actually be a plurality of signal lines. The bus 130 may be implemented as one channel including a plurality of signal lines or a plurality of channels. The bus 130 may be referred to as a channel, and, in some implementations described below, the bus 130 and a channel may be used as interchangeable terms.

The memory device 120 may write data or read data under the control by the memory controller 114. For example, the memory device 120 may be a DDR synchronous dynamic random access memory (SDRAM) device. However, the present disclosure is not limited thereto, and the memory device 120 may be any one of volatile memory devices, such as LPDDR SDRAM, wide I/O DRAM, a high bandwidth memory (HBM), and a hybrid memory cube (HMC). According to some implementations, the memory device 120 may be any one of non-volatile memory devices, such as flash memory, phase-change RAM (PRAM), magnetic RAM (MRAM), resistive RAM (RRAM), and ferroelectric RAM (FRAM).

The memory device 120 may include a memory cell array (MCA) 121, the PIM circuit 122, and a control logic circuit 126. The MCA 121 may be grouped into banks and may include a plurality of word lines, a plurality of bit lines, and a plurality of memory cells formed at points where the word lines intersect with the bit lines. The memory cells may each include a DRAM cell including one access transistor and one storage capacitor. However, the present disclosure is not limited thereto.

In some implementations, the MCA 121 may store a data set for neural network training. The memory device 120 may perform neural network training based on a data set stored in the MCA 121. A data set may be divided into plurality of batches, and the memory device 120 may train a neural network based on the plurality of batches. Accordingly, the memory device 120 may train a neural network a plurality of number of times based on one data set.

The PIM circuit 122 may include one or more processing elements 123 configured to execute a kernel offloaded by the host device 110. The host device 110 (e.g., the memory controller 114) may initiate a processing operation of the PIM circuit 122 by issuing a PIM command via the bus 130. The PIM circuit 122 may be hardware having processing functionality, similar to the processor 112 included in the host device 110.

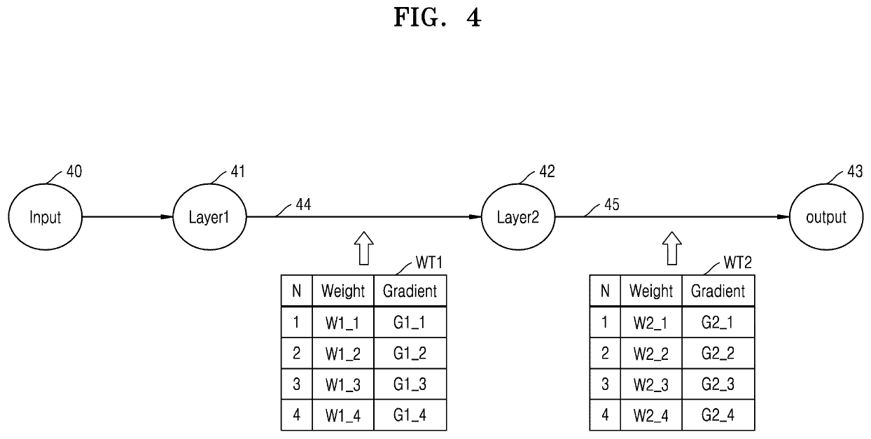

In some implementations, the PIM circuit 122 may include a plurality of PEs 123. Each of the plurality of PEs 123 may perform an operation in a neural network. For example, each of the plurality of PEs 123 may perform a multiplication operation of a weight and an activation described below with reference to FIG. 4. In some implementations, the number of plurality of PEs 123 may be equal to or greater than the number of links included in the neural network, but the inventive concept is not limited thereto. For example, the number of the plurality of PEs 123 may be greater than the number of a plurality of links between two consecutive layers.

In some implementations, the PIM circuit 122 may include a plurality of dedicated memories 124. The plurality of dedicated memories 124 may correspond to a plurality of links included in a neural network, respectively. In other words, the number of the plurality of dedicated memories 124 may be equal to the number of the plurality of links included in the neural network. Hereinafter, it is described that the number of the plurality of dedicated memories 124 is equal to the number of the plurality of links included in the neural network, but the number of the plurality of dedicated memories 124 according to the present disclosure is not limited thereto. For example, the number of the plurality of dedicated memories 124 may be equal to the number of the plurality of PEs 123.

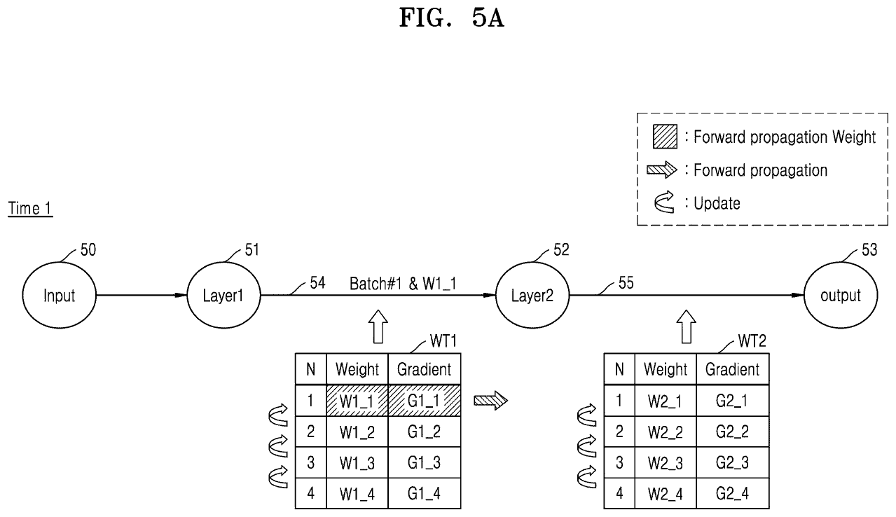

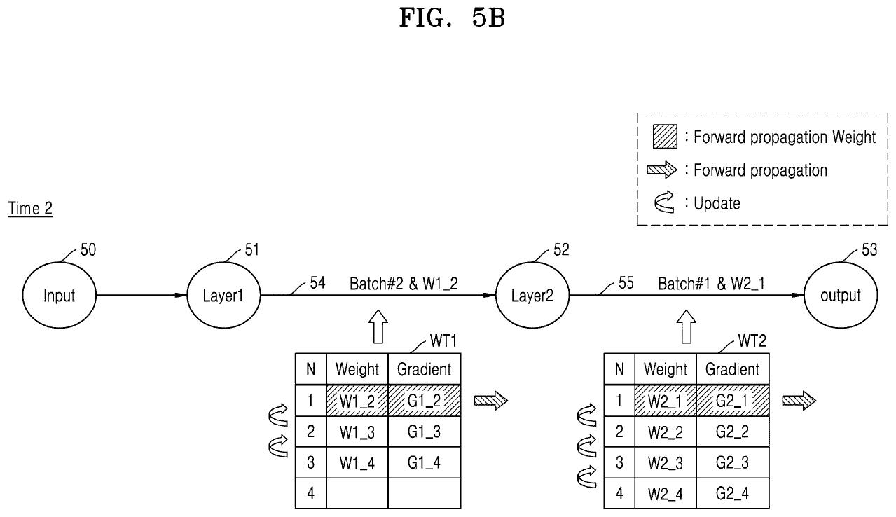

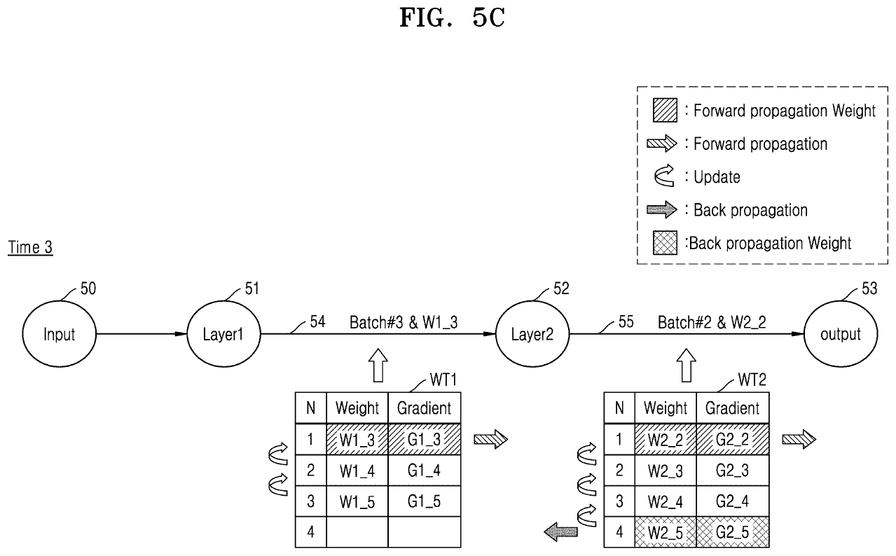

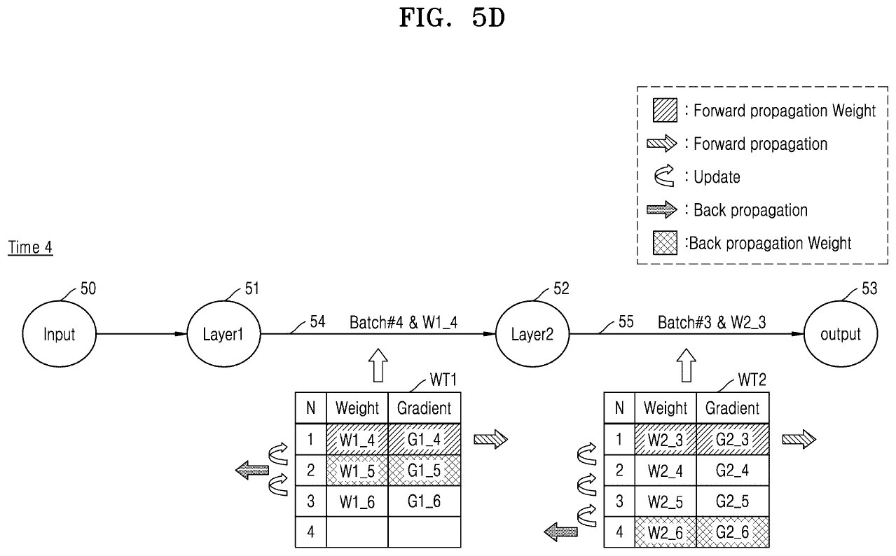

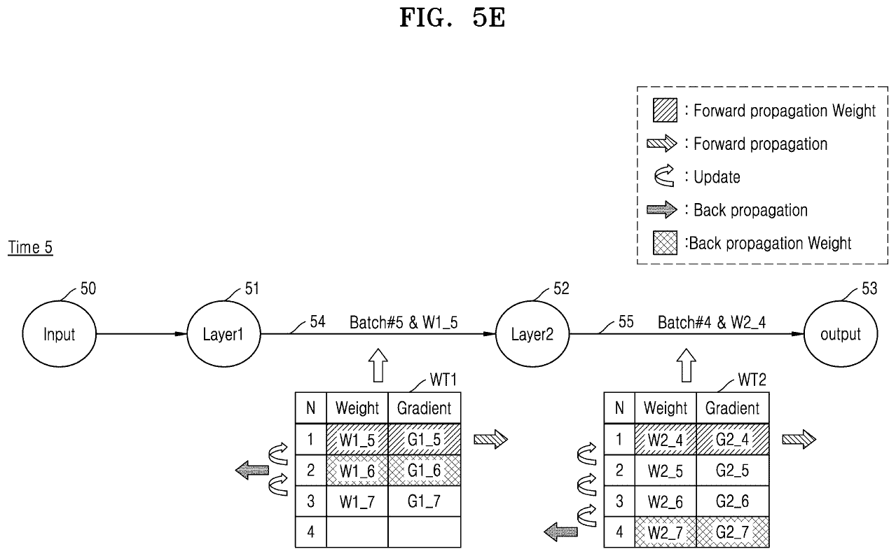

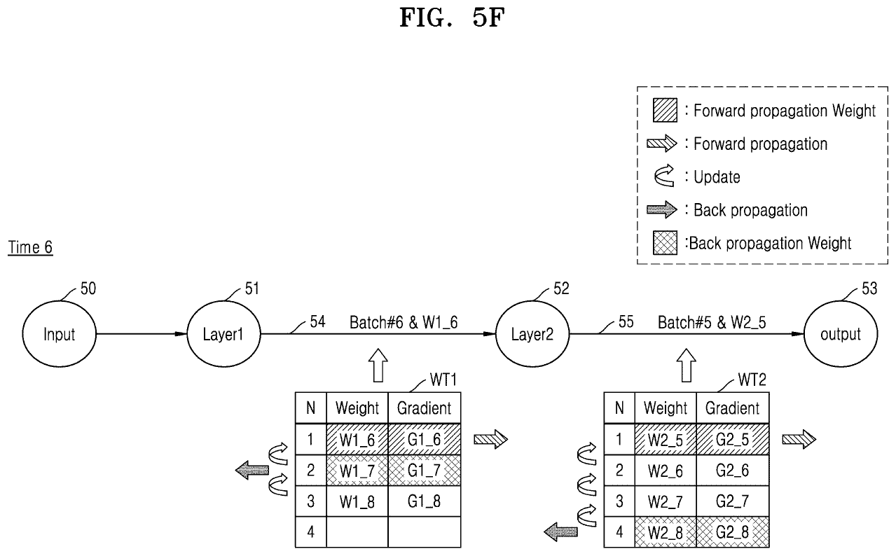

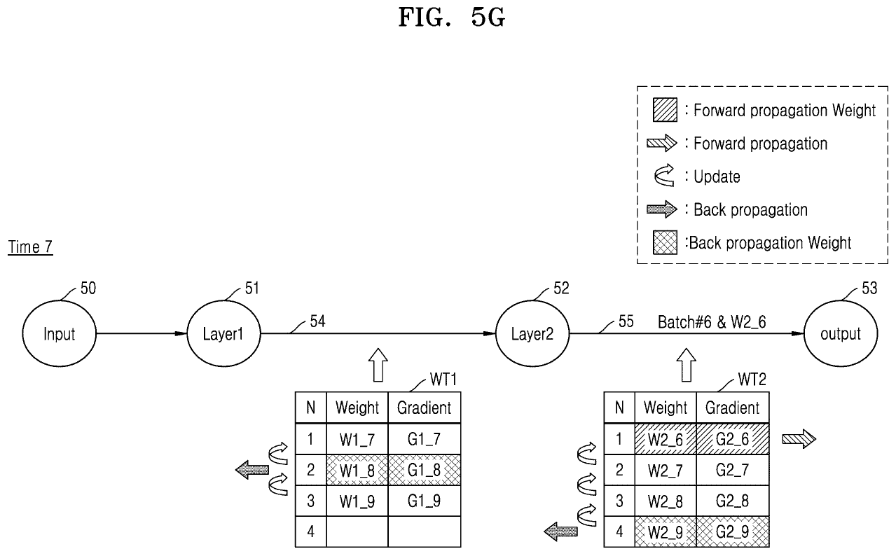

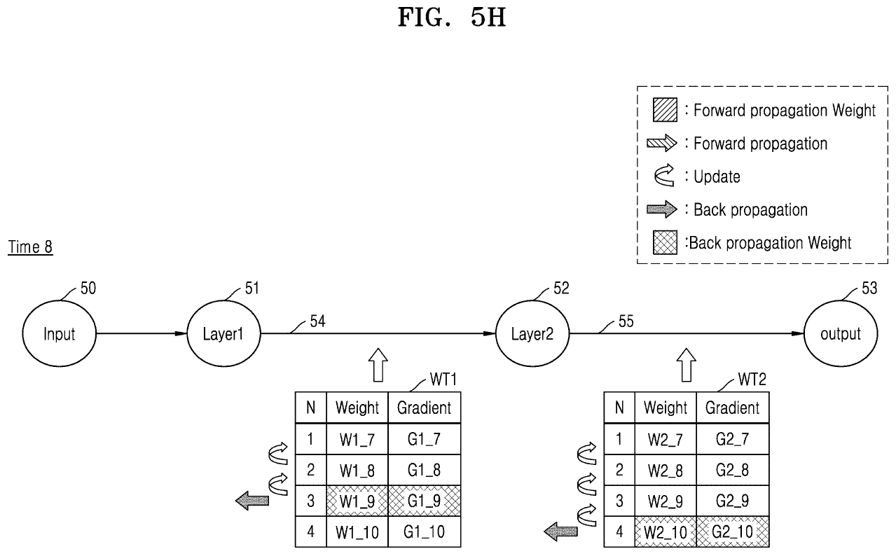

The plurality of dedicated memories 124 may correspond to a plurality of links and store a plurality of weights regarding corresponding links, respectively. In some implementations, a plurality of weights may include forward propagation weights, candidate weights, and back propagation weights. A forward propagation weight refer to a weight used in forward propagation for training or outputting a result of a neural network, a candidate weight refer to a weight that may be updated as a forward propagation weight or a back propagation weight, and a back propagation weight may refer to a weight used in back propagation for training a neural network. More detailed descriptions of a forward propagation weight, at least one candidate weight, and a back propagation weight are given below with reference to the drawings from FIG. 5A.

In some implementations, the memory device 120 may accelerate training of a neural network by including a plurality of dedicated memories respectively corresponding to a plurality of links. For example, the plurality of dedicated memories may include a plurality of weights for corresponding links, respectively. Based on a plurality of weights, the memory device 120 may perform forward propagation for other batches even before the plurality of weights are updated according to training, thereby reducing the time elapsed for training a neural network.

The control logic circuit 126 may control the overall operation of the memory device 120. The control logic circuit 126 may generate control signals to perform a write operation, a read operation, a refresh operation, and/or an internal processing operation of the memory device 120 based on a command CMD received from the memory controller 114.

In some implementations, the control logic circuit 126 may update at least one of candidate weights as a forward propagation weight after a forward propagation and/or back propagation operation according to an operation of a neural network. For example, the control logic circuit 126 may update a forward propagation weight by changing an address for the location where the forward propagation weight is stored to an address for the location where a candidate weight is stored. However, the present disclosure is not limited thereto, and the control logic circuit 126 may also update the forward propagation weight by copying and writing a candidate weight.

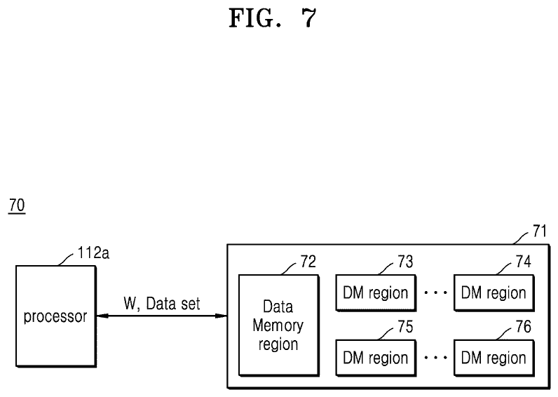

Although it has been described that an operation in an neural network according to some implementations is performed through the PIM circuit 122 with reference to FIG. 1, the memory device 120 is not limited thereto. For example, as described below with reference to FIG. 7, operations in a neural network may be performed through the processor 112.

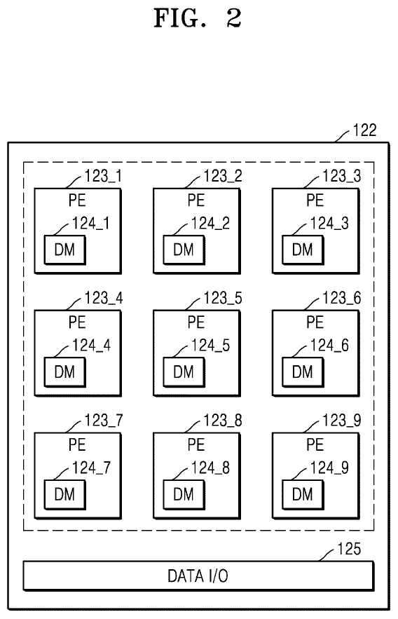

FIG. 2 is a block diagram showing an example of a memory device according to some implementations. In FIG. 2, the PIM circuit 122, a plurality of PEs 123_1 to 123_9, and a plurality of dedicated memories 124_1 to 124_9 correspond to the PIM circuit, PEs, and the dedicated memories described above with reference to FIG. 1, and descriptions thereof identical to those given above are omitted.

Referring to FIG. 2, the PIM circuit 122 may include the plurality of PEs 123_1 to 123_9, the plurality of dedicated memories 124_1 to 124_9, and a data input/output circuit 125.

In some implementations, the plurality of PEs 123_1 to 123_9 may each perform an operation for training and/or outputting a result of a neural network. The plurality of PEs 123_1 to 123_9 may each perform some of operations in a neural network, and remaining operations in the neural network may be performed by the processor (112 of FIG. 1) based on results of operations of the plurality of PEs 123_1 to 123_9. For example, the plurality of PEs 123_1 to 1239 may each perform a multiplication operation between an activation and a forward propagation weight in the neural network, and the remaining operations in the neural network (e.g., an operation for summing results of multiplication operations, an operation for applying a bias, etc.) may be performed by the processor (112 of FIG. 1).

The plurality of dedicated memories 124_1 to 1249 may each store a forward propagation weight, at least one candidate weight, and back propagation weights corresponding to each of a plurality of links included in the neural network. A plurality of weights stored in the plurality of dedicated memories 124_1 to 1249 may be updated as a forward propagation and/or back propagation is performed. For example, forward propagation weights stored in the plurality of dedicated memories 124_1 to 124_9 may be used for a forward propagation of the neural network. An used forward propagation weight may be deleted from a dedicated memory (e.g., 124_1), and at least one of candidate weights may be determined as a new forward propagation weight (or updated as a forward propagation weight). Similarly, a back propagation weight may be used for a back propagation in the neural network. However, unlike a forward propagation weight, a back propagation weight used in a back propagation may be updated as a candidate weights without being deleted and may later be updated as a forward propagation weight. A weight generated based on back propagation for training the neural network (hereinafter referred to as a training weight) may be stored in the dedicated memory (e.g., 124_1) as a candidate weight.

The PIM circuit 122 may receive a data set stored in the MCA (121 of FIG. 1) through the data input/output circuit 125 and perform neural network training through a neural network operation of a PE (e.g., 123_1) on a received data set. For example, as described above, the data input/output circuit 125 may divide the received data set into a plurality of batches and perform neural network training based on the plurality of batches. However, the present disclosure is not limited thereto.

In some implementations, the plurality of dedicated memories 124_1 to 124_9 configured to store a plurality of weights may be logically and physically separated from the MCA (121 of FIG. 1) configured to store a data set for training. Also, the plurality of dedicated memories 124_1 to 1249 may be logically and physically separated from one another, and the plurality of dedicated memories 124_1 to 124_9 may not share PEs with one another.

For convenience of explanation, it is illustrated that each of the plurality of PEs 123_1 to 123_9 includes a dedicated memory, but the present disclosure is not limited thereto. For example, the plurality of dedicated memories 124_1 to 124_9 may be logically allocated to the plurality of PEs 123_1 to 123_9, respectively, and may not be physically adjacent or directly connected.

Also, the numbers of the plurality of PEs 123_1 to 123_9 and the plurality of dedicated memories 124_1 to 124_9 illustrated in FIG. 2 are merely examples, and the present disclosure is not limited thereto.

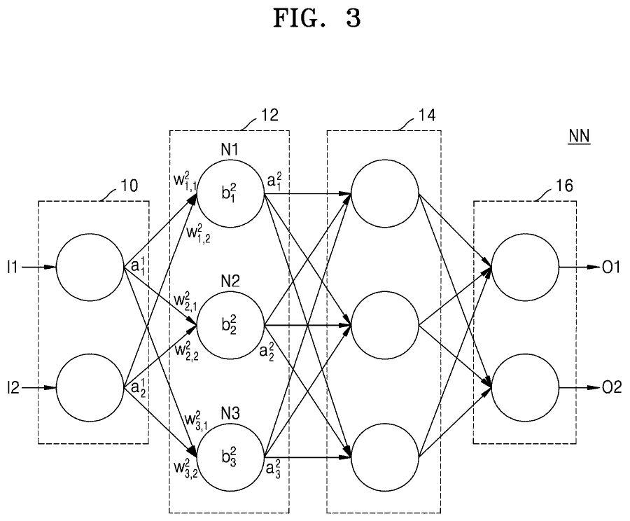

FIG. 3 is a block diagram for illustrating an example of a neural network according to some implementations. In FIG. 3, a neural network NN is intended to help understanding of a neural network structure (or referred to as a neural network model structure) according to the present disclosure, but the present disclosure is not limited thereto.

In FIG. 3, the neural network NN may have a structure including an input layer, hidden layers, and an output layer. The neural network NN may perform operations based on received input data I1 and 12 and generate output data O1 and O2 based on results of the operations. For example, as described above, a data set may be divided into a plurality of batches, and the neural network NN may use one batch as the input data I1 and 12 to generate the output data O1 and O2.

The neural network NN may be a deep neural network (DNN) or an n-layer neural network including two or more hidden layers. For example, the neural network NN may be a DNN including an input layer 10, a first hidden layer 12, a second hidden layer 14, and an output layer 16. A plurality of layers may be implemented as convolutional layers, fully-connected layers, softmax layers, etc. For example, a convolutional layer may include a convolution operation, a pooling operation, activation function operations, etc. In some implementations, a convolution operation, a pooling operation, and an activation function operation may each constitute a layer. However, a neural network model according to the present disclosure is not limited thereto.

Outputs of a plurality of layers, i.e., the input layer 10, the first hidden layer 12, the second hidden layer 14, and the output layer 16, may be referred to as features (or feature maps). The plurality of layers, i.e., the input layer 10, the first hidden layer 12, the second hidden layer 14, and the output layer 16, may receive features generated by previous layers as input features and generate output features or output signals by operating on the input features. Features may refer to data that expresses various characteristics of input data that may be recognized by the neural network NN.

When the neural network NN has a DNN structure, the neural network NN may include more layers from which valid information may be extracted, and the neural network NN may process complex data sets. Meanwhile, although it is illustrated that the neural network NN includes four layers, i.e., the input layer 10, the first hidden layer 12, the second hidden layer 14, and the output layer 16, this is merely an example, and the neural network NN may include fewer or more layers. Also, the neural network NN may include layers with various structures other than those illustrated in FIG. 5.

The plurality of layers, i.e., the input layer 10, the first hidden layer 12, the second hidden layer 14, and the output layer 16, included in the neural network NN may each include plurality of neurons. A plurality of neurons may correspond to a plurality of artificial nodes, known as units or similar terms. For example, as shown in FIG. 3, the input layer 10 may include two neurons (nodes), and the first hidden layer 12 and the second hidden layer 14 may each include three neurons (nodes). However, this is merely an example, and layers included in the neural network NN may include various numbers of neurons (nodes).

Neurons included in the plurality of layers, i.e., the input layer 10, the first hidden layer 12, the second hidden layer 14, and the output layer 16, included in the neural network NN may be connected to one another and exchange data. A neuron may receive data from other neurons, perform operations on the data, and output results of the operations to other neurons.

An input and an output of each of neurons (nodes, e.g., N1, N2, and N3) may be referred to as an input activation and an output activation. In other words, an activation may be a parameter corresponding to both the output of a neuron and the input of neurons in a next layer. Meanwhile, each neuron may determine its output activation based on output activations

$$( e . g . , {a}_{1}^{1} , {a}_{2}^{1} , {a}_{1}^{2} , {a}_{2}^{2} , {a}_{3}^{2} etc . )$$

received from neurons included in a previous layer, weights

$$( e . g . , {W}_{1 , 1}^{2} , {W}_{1 , 2}^{2} , {W}_{2 , 2}^{2} , {W}_{3 , 1}^{2} , {W}_{3 , 2}^{2} , {W}_{3 , 2}^{2} etc . )$$

and biases

$$( e . g . , {b}_{1 ,}^{2} , {b}_{2 ,}^{2} , {b}_{3}^{2} etc . ) .$$

Weights and biases are parameters (may be referred to as weight parameters) used to calculate the output activation from each neuron, wherein the weights are values assigned to the connection relationships between the neurons, and the biases represent coefficients related individual neurons. The neural network NN may determine parameters such as weights and biases, such that a loss value generated by a loss function is minimized.

The neural network NN may include a plurality of links. The plurality of links may each represent a multiplication operation between an activation output from a neuron contained in a previous layer

$$( e . g . , {a}_{1}^{1} )$$

and a weight

$$( e . g . , {w}_{1 , 1}^{2} ) .$$

Accordingly, a multiplication operation corresponding to a link may be performed by the PE (e.g., 123_1) described above with reference to FIG. 2. At this time, the weight used in the multiplication operation (e.g., the forward propagation weight) may be a weight stored in the dedicated memory 124_1.

FIG. 4 is a diagram for illustrating an example of a neural network and weights corresponding to links included in the neural network according to some implementations. FIG. 4 may be described with reference to FIG. 3, and descriptions identical to those given above may be omitted.

In FIG. 4, a neural network may include an input layer 40, a first layer 41, a second layer 42, and an output layer 43. The first layer 41 and the second layer 42 may be hidden layers as described above. FIG. 4 illustrates that each of the input layer 40, the first layer 41, the second layer 42, and the output layer 43 includes one neuron for convenience of explanation, and it is illustrated that one link exists between two consecutive layers. This is merely for convenience of explanation, and a neural network according to the present disclosure may include more hidden layers and a plurality of neurons may be included in each of the plurality of layers, and a plurality of links may exist between two consecutive layers.

The neural network may include the first layer 41 and the second layer 42, and may include a first link 44 between the first layer 41 and the second layer 42. Similarly, the neural network may include the second layer 42 and the output layer 43, and may include a second link 45 between the second layer 42 and the output layer 43.

A first dedicated memory (e.g., 124_1 of FIG. 2) may store a plurality of weights W1_1 to W1_4 corresponding to the first link 44, i.e., a first weight table WT1. Similarly, a second dedicated memory (e.g., 124_2 of FIG. 2) may store a plurality of weights W2_1 to W2_4 corresponding to the second link 45, i.e., a second weight table WT2. The number of a plurality of weights stored in a dedicated memory according to the present disclosure may be determined based on the number of a plurality of hidden layers included in a neural network. For example, the number of a plurality of weights stored in each of a plurality of dedicated memories may be twice or greater than the number of a plurality of layers included in a neural network. In FIG. 4, since the number of hidden layers is two, the number of a plurality of weights stored in each of a plurality of dedicated memories may be four or more.

In FIG. 4, the first weight table WT1 may include a plurality of gradients G1_1 to G1_4 together with the plurality of weights W1_1 to W1_4. The plurality of gradients G1_1 to G1_4 may correspond to the plurality of weights W1_1 to W1_4, respectively. The plurality of gradients G1_1 to G1_4 may be determined based on the plurality of weights W1_1 to W1_4, respectively. For example, a memory device according to the inventive concept may determine reciprocals of the plurality of weights W1_1 to W1_4 as the plurality of gradients G1_1 to G1_4, respectively. Similarly, the second weight table WT2 may include a plurality of gradients G2_1 to G2_4 together with the plurality of weights W2_1 to W2_4, and reciprocals of the plurality of weights W2_1 to W2_4 may be determined as the plurality of gradients G2_1 to G2_4. Weights included in a weight table may be used for forward propagation of a neural network, and gradients included in the weight table may be used for back propagation of the neural network.

However, in some implementations, a weight table is not limited to the weight table (e.g., WT1) illustrated in FIG. 4. For example, a memory device may store only a plurality of weights respectively corresponding to a plurality of links included in a neural network in dedicated memories and may not store a plurality of gradients respectively corresponding to the plurality of weights. A plurality of stored weights may be used when performing a forward propagation operation of a neural network, and reciprocals of the plurality of stored weights may be used when performing a back propagation operation of the neural network.

FIGS. 5A to 5H are diagrams for illustrating an example of an operation of a neural network according to some implementations. FIGS. 5A to 5H may be described with reference to FIGS. 3 and 4, and descriptions identical to those given above will be omitted. An input layer 50, a first layer 51, a second layer 52, an output layer 53, a first link 54, and a second link 55 illustrated in FIGS. 5A to 5H respectively correspond to the input layer 40, the first layer 41, the second layer 42, the output layer 43, the first link 44, and the second link 45 illustrated in FIG. 4 respectively, and descriptions identical to those given above will be omitted. It may be understood that the first weight table WT1 is stored in a first dedicated memory (e.g., 124_1 of FIG. 2) logically allocated to a first PE (e.g., 1231 of FIG. 2), and the second weight table WT2 is stored in a second dedicated memory (e.g., 124_2 of FIG. 2) logically allocated to a second PE (e.g., 123_2 of FIG. 2). Hereinafter, a neural network operation of a memory device according to the present disclosure is described with reference to FIGS. 5A to 5H. In FIGS. 5A to 5H, it is assumed below that a data set for training a neural network is divided into six batches, but the number of batches for training a neural network according to the present disclosure may be more or less than six.

In FIG. 5A, during a first time period Time 1, a memory device may perform an operation for forward propagation. During the first time period Time 1, the memory device may perform an operation for forward propagation of a neural network on a first batch Batch #1 based on a first forward propagation weight W1_1. For example, the memory device (or a first PE) may perform a multiplication operation between an activation for the first batch Batch #1 output from the first layer 51 and the first forward propagation weight W1_1. Meanwhile, during the first time period Time 1, the memory device is unable to perform an operation corresponding to the second link 55, because there is no output from the second layer 52. After performing forward propagation on the first batch Batch #1, the first forward propagation weight W1_1 may be updated to one of a plurality of first candidate weights W1_2 to W1_4. For example, the first forward propagation weight W1_1 may be deleted from a first dedicated memory, and a first forward propagation weight may be updated with a first candidate weight W1_2.

In FIG. 5A, the order of the plurality of first candidate weights W1_2 to W1_4 stored in the first dedicated memory may be changed. For example, the order of the first candidate weight W1_2 may be changed from second to first, and thus the first forward propagation weight may be updated with the first candidate weight W1_2. As described above, since a plurality of gradients may be determined based on corresponding weights, the order of the gradients may be changed similarly as that described above after the forward propagation operation of the neural network. In other words, a weight and a gradient corresponding to the weight form a pair, and the order of a weight and a gradient corresponding to each other in a weight table may be the same.

The initial plurality of weights stored in the first weight table WT1 and the initial plurality of weights stored in the second weight table WT2 illustrated in FIG. 5A may be identical to each other. For example, before the operation for forward propagation of the neural network is performed, all of the plurality of weights W1_1 to W1_4 stored in the first weight table WT1 may have the same value. Similarly, before the operation for forward propagation of the neural network is performed, all of the plurality of weights W2_1 to W2_4 stored in the second weight table WT2 may have the same value. As described above, since a plurality of gradients may be determined based on corresponding weights, all gradients stored in a weight table before an operation for forward propagation of a neural network may have the same value.

In FIG. 5B, during a second time period Time 2, the memory device may perform an operation for forward propagation. During the second time period Time 2, the memory device (or a first PE) may perform an operation for forward propagation of the neural network on a second batch Batch #2 based on a first forward propagation weight W1_2. For example, the memory device may perform a multiplication operation between an activation for the second batch Batch #2 output from the first layer 51 and the first forward propagation weight W1_2. Also, during the second time period Time 2, the memory device (or a second PE) may perform an operation for forward propagation of the neural network on the first batch Batch #1 based on a second forward propagation weight W2_1. For example, the memory device may perform a multiplication operation between an activation for the first batch Batch #1 output from the second layer 52 and the second forward propagation weight W2_1. The operation by the first PE and the operation by the second PE described above with reference to FIG. 5B may be performed simultaneously. Since updating a weight may be understood through the descriptions given above with reference to FIG. 5A, detailed description thereof is omitted.

In some implementations, a memory device may perform forward propagation without waiting for updating of weights according to training of a neural network based on a plurality of dedicated memories configured to store a plurality of weights. As described above with reference to FIG. 5B, the memory device may perform an operation for the second batch Batch #2 based on the first forward propagation weight W1_2 and an operation for the first batch Batch #1 based on the second forward propagation weight W2_1 together. Accordingly, the time elapsed for neural network training may be reduced.

In FIGS. 5B and 5C, after an operation corresponding to the second link 55, a second candidate weight W2_5 may be generated as a result of training on the first batch Batch #1 based on output data of the output layer 53, and the second candidate weight W2_5 may be added to the second weight table WT2. As described above, a gradient G2_5 corresponding to the second candidate weight W2_5 may be added to the second weight table WT2 together with the second candidate weight W2_5 and used for a back propagation operation. However, the present disclosure is not limited thereto, and the gradient G2_5 may be calculated based on the second candidate weight W2_5 during the back propagation operation and then used for the back propagation operation.

In FIG. 5C, during a third time period Time 3, the memory device may perform an operation for forward propagation. During the third time period Time 3, the memory device (or the first PE) may perform an operation for forward propagation of the neural network on a third batch Batch #3 based on a first forward propagation weight W1_3. For example, the memory device may perform a multiplication operation between an activation for the third batch Batch #3 output from the first layer 51 and the first forward propagation weight W1_3. Also, during the third time period Time 3, the memory device (or the second PE) may perform an operation for forward propagation of the neural network on the second batch Batch #2 based on a second forward propagation weight W2_2. For example, the memory device may perform a multiplication operation between an activation for the second batch Batch #2 output from the second layer 52 and the second forward propagation weight W2_2. Also, during the third time period Time 3, the memory device (or the second PE) may perform an operation for back propagation based on the second candidate weight W2_5, which is a result of training on the first batch Batch #1. The second candidate weight W2_5 may be referred to as a training weight, because it is based on a result of training on the first batch Batch #1 as described above.

In FIG. 5C, the second candidate weight W2_5 may be referred to as a back propagation weight. An operation for back propagation may mean an operation to change a weight corresponding to a link (to minimize the error in an output of a neural network), through which the neural network may be trained. Changing the order of weights included in a weight table may be performed after an operation for forward propagation. The memory device may update the second candidate weight W2_5 as a candidate weight after a back propagation operation based on the second candidate weight W2_5 is performed.

As described above, with reference to FIG. 5C, the memory device may perform an operation for the third batch Batch #3 based on the first forward propagation weight W1_3 and an operation for the second batch Batch #2 based on the second forward propagation weight W2_2 together. Accordingly, the time elapsed for neural network training may be reduced.

FIGS. 5D to 5H may be understood through the descriptions given above with reference to FIGS. 5A to 5C. Accordingly, descriptions identical to those already given above will be omitted.

In FIG. 5D, during a fourth time period Time 4, the memory device may perform an operation for forward propagation. During the fourth time period Time 4, the memory device (or the first PE) may perform an operation for forward propagation of the neural network on a fourth batch Batch #4 based on a first forward propagation weight W1_4. For example, the memory device may perform a multiplication operation between an activation for the fourth batch Batch #4 output from the first layer 51 and the first forward propagation weight W1_4. Also, during the fourth time period Time 4, the memory device (or the second PE) may perform an operation for forward propagation of the neural network on the third batch Batch #3 based on a second forward propagation weight W2_3. For example, the memory device may perform a multiplication operation between an activation for the third batch Batch #3 output from the second layer 52 and the second forward propagation weight W2_3. Also, during the fourth time period Time 4, the memory device (e.g., the first PE) may perform an operation for back propagation based on a first candidate weight W1_5, which is a result of training on the first batch Batch #1, and the memory device (e.g., the second PE) may perform an operation for back propagation based on a second candidate weight W2_6, which is a result of training on the second batch Batch #2.

In FIG. 5E, during a fifth time period Time 5, the memory device may perform an operation for forward propagation. During the fifth time period Time 5, the memory device (or the first PE) may perform an operation for forward propagation of the neural network on a fifth batch Batch #5 based on a first forward propagation weight W1_5. For example, the memory device may perform a multiplication operation between an activation for the fifth batch Batch #5 output from the first layer 51 and the first forward propagation weight W1_5. As described above, the first forward propagation weight W1_5 is a weight based on a result of training the neural network on the first batch Batch #1. Also, during the fifth time period Time 5, the memory device (or the second PE) may perform an operation for forward propagation of the neural network on the fourth batch Batch #4 based on a second forward propagation weight W2_4. For example, the memory device may perform a multiplication operation between an activation for the fourth batch Batch #4 output from the second layer 52 and the second forward propagation weight W2_4. Also, during the fifth time period Time 5, the memory device (e.g., the first PE) may perform an operation for back propagation based on a first candidate weight W1_6, which is a result of training on the second batch Batch #2, and the memory device (e.g., the second PE) may perform an operation for back propagation based on a second candidate weight W2_7, which is a result of training on the third batch Batch #3. A first candidate weight W1_7 may be generated through back propagation performed based on the second candidate weight W2_7.

In FIG. 5F, during a sixth time period Time 6, the memory device may perform an operation for forward propagation. During the sixth time period Time 6, the memory device (or the first PE) may perform an operation for forward propagation of the neural network on a sixth batch Batch #6 based on a first forward propagation weight W1_6. For example, the memory device may perform a multiplication operation between an activation for the sixth batch Batch #6 output from the first layer 51 and the first forward propagation weight W1_6. It may be understood that, as described above, the first forward propagation weight W1_6 is a weight based on a result of training the neural network on the second batch Batch #2. Also, during the sixth time period Time 6, the memory device (or the second PE) may perform an operation for forward propagation of the neural network on the fifth batch Batch #5 based on a second forward propagation weight W2_5. For example, the memory device may perform a multiplication operation between an activation for the fifth batch Batch #5 output from the second layer 52 and the second forward propagation weight W2_5. Also, during the sixth time period Time 6, the memory device (e.g., the first PE) may perform an operation for back propagation based on a first candidate weight W1_7, which is a result of training on the third batch Batch #3, and the memory device (e.g., the second PE) may perform an operation for back propagation based on a second candidate weight W2_8 (i.e., determined as a back propagation weight), which is a result of training on the fourth batch Batch #4. The first candidate weight W1_8 may be generated through back propagation performed based on the second candidate weight W2_8.

In FIG. 5G, during a seventh time period Time 7, the memory device may perform an operation for forward propagation. During the seventh time period Time 7, the memory device (or the second PE) may perform an operation for forward propagation of the neural network on the sixth batch Batch #6 based on a second forward propagation weight W2_6. For example, the memory device may perform a multiplication operation between an activation for the sixth batch Batch #6 output from the second layer 52 and the second forward propagation weight W2_6. Also, during the seventh time period Time 7, the memory device (e.g., the first PE) may perform an operation for back propagation based on a first candidate weight W1_8, which is a result of training on the fourth batch Batch #4, and the memory device (e.g., the second PE) may perform an operation for back propagation based on a second candidate weight W2_9 (i.e., determined as a back propagation weight), which is a result of training on the fifth batch Batch #5. The first candidate weight W1_9 may be generated through back propagation performed based on the second candidate weight W2_9.

In FIG. 5H, during an eighth time period Time 8, the memory device (e.g., the first PE) may perform an operation for back propagation based on a first candidate weight W1_9, which is a result of training on the fifth batch Batch #5, and the memory device (e.g., the second PE) may perform an operation for back propagation based on a second candidate weight W2_10 (i.e., determined as a back propagation weight), which is a result of training on the sixth batch Batch #6.

The first candidate weight W1_10 may be generated through back propagation performed based on the second candidate weight W2_10.

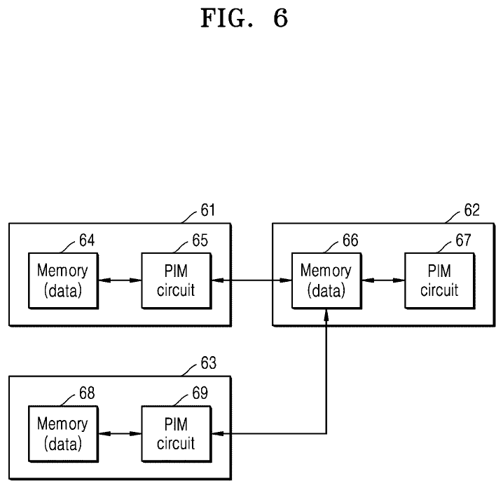

FIG. 6 is a block diagram for illustrating an example of a memory device according to some implementations. In FIG. 6, a first memory device 61, a second memory device 62, and a third memory device 63 may be electrically connected to one another. Since the first memory device 61, the second memory device 62, and the third memory device 63 each correspond to the memory device 120 described above with reference to FIG. 1, descriptions identical to those already given above will be omitted.

In FIG. 6, the first memory device 61, the second memory device 62, and the third memory device 63 may include memories 64, 66, and 68 configured to store data sets for training a neural network and PIM circuits 65, 67, and 69 configured to perform operations for forward propagation and back propagation of the neural network, respectively.

A neural network may include plurality of layers to generate accurate output data regarding input data. As the number of layers increases, the accuracy of output data may improve. However, since the number of links included in the neural network may increase, time elapsed for operations may increase. As described above, the memory device (120 of FIG. 1) according to the present disclosure may include a plurality of dedicated memories (e.g., 124_1 to 124_9 of FIG. 2) corresponding to a plurality of links included in the neural network, respectively. As described above, the plurality of dedicated memories (e.g., 124_1 to 124_9 of FIG. 2) according to the present disclosure may store a plurality of weights for corresponding links, respectively.

However, the number of plurality of links included in the neural network may be greater than the number of the plurality of dedicated memories included in memory devices 61, 62 and 63. Also, as described above, the plurality of dedicated memories may be physically and logically separated from memories for storing data sets, and the plurality of dedicated memories may be physically and logically separated from one another. Accordingly, as illustrated in FIG. 6, a plurality of memory devices 61, 62, and 63 may be connected to one another to perform operations for forward propagation and back propagation of the neural network described above.

After training is complete, the memory device may determine a final weight based on a plurality of (or multiple) weights stored in the dedicated memories. The memory device may determine a combination of the plurality of weights as the final weight. For example, the memory device may determine the average of the plurality of weights as the final weight. The memory device may generate an output of the neural network by using the final weight.

FIG. 7 is a block diagram for illustrating an example of an electronic device according to some implementations. In FIG. 7, an electronic device 70 may include a processor 112a and a memory 71. The processor 112a may correspond to the processor 112 described above with reference to FIG. 1, and descriptions identical to those already given above will be omitted.

The memory 71 may include plurality of memory regions. The plurality of memory regions included in the memory 71 may be logically separated from one another. The memory 71 according to the inventive concept may include a data memory region 72 configured to store a data set for training a neural network and a plurality of dedicated memory regions 73 to 76 configured to store a plurality of weights corresponding to links of the neural network.

Although it has been described with reference to FIGS. 1 to 6 that operations for forward propagation and/or back propagation of a neural network are performed based on PEs and dedicated memories, the present disclosure is not limited thereto. For example, as illustrated in FIG. 7, the processor 112a included in the electronic device 70 may serve as the PE described above. Also, the plurality of dedicated memory regions 73 to 76 logically separated from one another may correspond to the plurality of dedicated memories, respectively.

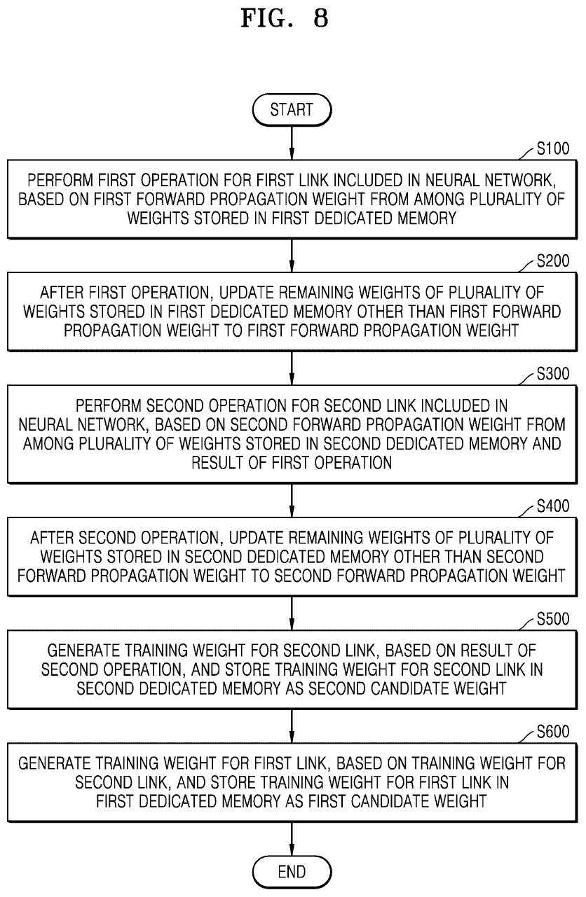

FIG. 8 is a flowchart of an example of a method of operating a memory device according to some implementations. In FIG. 8, in operation S100, a memory device may perform a first operation for a first link included in a neural network based on a first forward propagation weight from among a plurality of weights stored in a first dedicated memory.

In operation S200, after the first operation, the memory device may update weights other than the first forward propagation weights from among the plurality of weights stored in the first dedicated memory as first forward propagation weights. Here, the memory device may delete the first forward propagation weight used in the first operation from the first dedicated memory.

In operation S300, the memory device may perform a second operation for a second link included in the neural network based on a second forward propagation weight from among a plurality of weights stored in a second dedicated memory and a result of the first operation.

In operation S400, after the second operation, the memory device may update weights other than the second forward propagation weights from among the plurality of weights stored in the second dedicated memory as second forward propagation weights. Here, the first dedicated memory and the second dedicated memory may be physically and logically separated from each other. Also, as described above, the neural network includes N hidden layers (N is an integer greater than or equal to 1), and the number of the plurality of weights stored in each of the first dedicated memory and the second dedicated memory may be 2× or greater. Also, the memory device may delete the second forward propagation weight used in the second operation from the second dedicated memory.

In operation S500, the memory device may generate a training weight for the second link based on a result of the second operation and store the training weight for the second link as a second candidate weight in the second dedicated memory.

In operation S600, the memory device may generate a training weight for the first link based on the training weight for the second link and store the training weight for the first link as a first candidate weight in the first dedicated memory.

A data set used for training a neural network includes a first batch and a second batch consecutive to the first batch, and the neural network may perform learning on the second batch after learning on the first batch, wherein a second operation on the first batch and a first operation on the second batch may be performed together.

After the training of the neural network is completed, a final weight for each of the first link and the second link may be determined based on multiple weights stored in each of the first dedicated memory and the second dedicated memory.

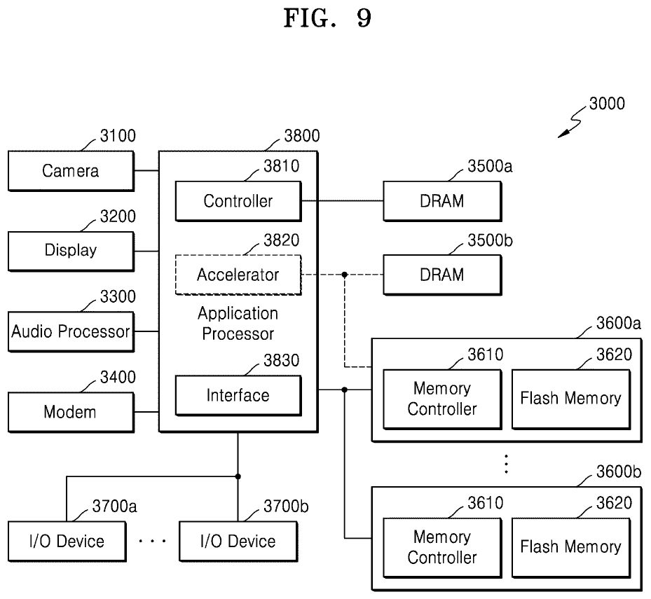

FIG. 9 is a block diagram of an example of a system for describing an electronic device including a memory device according to some implementations. In FIG. 9, a system 3000 may include a camera 3100, a display 3200, an audio processor 3300, a modem 3400, DRAMs 3500a and 3500b, flash memories 3600a and 3600b, I/O devices 3700a and 3700b, and an application processor (AP) 3800. The system 3000 may be implemented as a laptop computer, a mobile phone, a smartphone, a tablet PC, a wearable device, a healthcare device, or an IoT device. Also, the system 3000 may be implemented as a server or a PC.

The camera 3100 may capture a still image or a video according to a user's control and may store captured image/video data or transmit the captured image/video data to the display 3200. The audio processor 3300 may process audio data included in the flash memories 3600a and 3600b or network content. The modem 3400 may transmit a modulated signal for wired/wireless data transmission/reception to a receiver and the modulated signal may be demodulated by the receiver to restore an original signal. The I/O devices 3700a and 3700b may include devices providing a digital input function and/or digital output function, e.g., a Universal Serial Bus (USB), a storage, a digital camera, a Secure Digital (SD) card, a Digital Versatile Disc (DVD), a network adapter, a touch screen, etc.

The AP 3800 may control the overall operation of the system 3000. The AP 3800 may include a control block 3810, an accelerator block or accelerator chip 3820, and an interface block 3830. The AP 3800 may control the display 3200, such that a part of content stored in the flash memories 3600a and 3600b is displayed on the display 3200. When a user input is received through the I/O devices 3700a and 3700b, the AP 3800 may perform a control operation corresponding to the user input. The AP 3800 may include an accelerator block, which is a circuit dedicated for calculation of artificial intelligence (AI) data, or may include an accelerator chip 3820 separately from the AP 3800. A DRAM 3500b may be additionally provided in the accelerator block or the accelerator chip 3820. The accelerator block is a functional block that specializes in performing a particular function of the AP 3800 and may include a graphics processing unit (GPU), which is a functional block that specializes in processing graphic data, a neural processing unit (NPU), which is a block that specializes in AI calculation and inference, and a data processing unit (DPU), which is a block that specializes in data transmission.

The system 3000 may include a plurality of DRAMs 3500a and 3500b. The AP 3800 may set up a DRAM interface protocol and communicate with the DRAMs 3500a and 3500b to control the DRAMs 3500a and 3500b through commands complying with the JEDEC standard and mode register (MRS) setting or to use company-specific functions, such as low voltage/high-speed/reliability and a cyclic redundancy check (CRC)/error correction code (ECC) function. For example, the AP 3800 may communicate with a DRAM 3500a through an interface complying with the JEDEC standards such as LPDDR4 and LPDDR5, and the accelerator block or the accelerator chip 3820 may set and use a new DRAM interface protocol to control the DRAM 3500b for an accelerator, which has a greater bandwidth than the DRAM 3500a.

Although FIG. 9 shows only the DRAMs 3500a and 3500b, the present disclosure is not limited thereto. As long as a bandwidth, a response speed, and voltage conditions of the AP 3800 or the accelerator chip 3820 are satisfied, any memory like a PRAM, an SRAM, an MRAM, an RRAM, an FRAM, or a Hybrid RAM may be used. The DRAMs 3500a and 3500b have relatively smaller latency and bandwidth than the I/O devices 3700a and 3700b or the flash memories 3600a and 3600b. The DRAMs 3500a and 3500b are initialized when the system 3000 is powered on and the OS and application data are loaded thereto, and the DRAMs 2500a and 2500b may be used as temporary storages for the OS and the application data or may be used as execution spaces for various software code.

In the DRAMs 3500a and 3500b, four arithmetic operations (i.e., addition, subtraction, multiplication, and division), vector calculations, address calculations, or Fast Fourier Transform (FFT) calculations may be performed. Also, in the DRAMs 3500a and 3500b, a function for an operation used for an inference may be performed. Here, the inference may be performed in a deep learning algorithm using an artificial neural network. The deep learning algorithm may include a training operation for learning a model through various data and an inference operation for recognizing data with the trained model. According to some implementations, an image captured by a user through the camera 3100 is signal-processed and stored in the DRAM 3500b, and the accelerator block or accelerator chip 3820 may perform AI data calculation for recognizing data using data stored in the DRAM 3500b and a function used for inference.

The system 3000 may include a plurality of storages or flash memories 3600a and 3600b having a larger capacity than the DRAMs 3500a and 3500b. The accelerator block or accelerator chip 3820 may perform a training operation and an AI data calculation using the flash memories 3600a and 3600b. According to some implementations, the flash memories 3600a and 3600b may include a memory controller 3610 and a flash memory device 3620, and a training operation and an inference AI data calculation performed by the AP 3800 and/or the accelerator chip 3820 may be performed more efficiently by using an arithmetic unit included in the memory controller 3610. The flash memories 3600a and 3600b may store images captured through the camera 3100 or data transmitted through a data network. For example, the flash memories 2600a and 2600b may store Augmented Reality/Virtual Reality content, High Definition (HD) content, or Ultra High Definition (UHD) content.

In the system 3000, the DRAMs 3500a and 3500b may include the memory device described above with reference to FIGS. 1 to 8.

While this disclosure contains many specific implementation details, these should not be construed as limitations on the scope of what may be claimed, equivalents thereof, as well as claims to be described later. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

What is claimed is:

1. A memory device configured to perform neural network learning, the memory device comprising:
a first dedicated memory corresponding to a first link included in a neural network and configured to store a first plurality of weights, wherein the first plurality of weights comprises a first forward propagation weight and at least one first candidate weight for the first link; and
a first processing element (PE) configured to perform a multiplication operation between an input and the first forward propagation weight stored in the first dedicated memory, for the first link,
wherein the memory device is configured to update the first forward propagation weight stored in the first dedicated memory with one of the at least one first candidate weight after the multiplication operation for the first link corresponding to the first dedicated memory.

2. The memory device of claim 1, further comprising a plurality of dedicated memories corresponding to a plurality of links included in the neural network, respectively,
wherein the plurality of dedicated memories are physically and logically separated from each other.

3. The memory device of claim 1, further comprising a plurality of PEs configured to perform forward propagation in the neural network,
wherein the neural network comprises two consecutive layers and a plurality of links between the two consecutive layers, and
wherein a number of the plurality of PEs is greater than a number of the plurality of links between the two consecutive layers.

4. The memory device of claim 1,
wherein the neural network comprises N hidden layers, wherein N is an integer greater than or equal to 1, and
wherein a number of the first plurality of weights stored in the first dedicated memory is 2×N or greater.

5. The memory device of claim 1,
wherein the neural network further comprises a second link sharing neurons with the first link,
wherein the memory device further comprises:
a second dedicated memory configured to store a second plurality of weights, wherein the second plurality of weights comprises a second forward propagation weight and at least one second candidate weight, for the second link; and
a second PE configured to perform a multiplication operation between an input and the second forward propagation weight stored in the second dedicated memory, for the second link, and
wherein the second PE is configured to
generate an additional weight, through training of the neural network from among the at least one second candidate weight, as a second back propagation weight and,
based on the second back propagation weight, to generate a training weight for the first link, wherein the first dedicated memory is configured to store the training weight.

6. The memory device of claim 5, wherein the memory device is configured to delete the first forward propagation weight from the first dedicated memory after the multiplication operation for the first link.

7. The memory device of claim 6, wherein the memory device is configured to determine a final weight for the first link based on a combination of multiple weights stored in the first dedicated memory and the second dedicated memory after the training of the neural network is completed.

8. The memory device of claim 1, further comprising:
a plurality of dedicated memories corresponding to a plurality of links included in the neural network, respectively; and
a plurality of PEs respectively corresponding to the plurality of dedicated memories.

9. The memory device of claim 1, further comprising a data memory configured to store a data set for training the neural network,
wherein the first PE is physically and logically separated from the data memory.

10. The memory device of claim 1,
wherein the first dedicated memory is configured to store a forward propagation weight gradient corresponding to the first forward propagation weight and at least one candidate weight gradient corresponding to the at least one first candidate weight, respectively, and
wherein the first PE is configured to perform back propagation, based on the at least one candidate weight gradient.

11. An operating method of a memory device, the method comprising:
performing a first operation on a first link included in a neural network, based on a first forward propagation weight from among a plurality of weights stored in a first dedicated memory;
after performing the first operation, updating the first forward propagation weight with a different weight from among the plurality of weights stored in the first dedicated memory;
performing a second operation on a second link included in the neural network, based on a second forward propagation weight from among a plurality of weights stored in a second dedicated memory and on a result of the first operation;
after performing the second operation, updating the second forward propagation weight with a different weight from among the plurality of weights stored in the second dedicated memory;
generating a training weight for the second link, based on a result of the second operation, and storing the training weight for the second link as a second candidate weight in the second dedicated memory; and
generating a training weight for the first link, based on the training weight for the second link and storing the training weight for the first link as a first candidate weight in the first dedicated memory.

12. The method of claim 11, wherein the first dedicated memory and the second dedicated memory are physically and logically separated from each other.

13. The method of claim 11,
wherein the neural network comprises N hidden layers, wherein N is an integer equal to 1 or greater, and
wherein a number of weights stored in each of the first dedicated memory and the second dedicated memory is 2×N or greater.

14. The method of claim 11,
wherein updating of the first forward propagation weight with a different weight from among the plurality of weights stored in the first dedicated memory comprises deleting the first forward propagation weight used in the first operation from the first dedicated memory, and
wherein updating of the second forward propagation weight with a different weight from among the plurality of weights stored in the second dedicated memory comprises deleting the second forward propagation weight used in the second operation from the second dedicated memory.

15. The method of claim 14, further comprising, after training of the neural network is completed, determining a plurality of final weights for each of the first link and the second link, based on a combination of multiple weights stored in each of the first dedicated memory and the second dedicated memory.

16. The method of claim 11,
wherein a data set used for training the neural network comprises a first batch and a second batch,
wherein the neural network is configured to perform learning on the second batch after performing learning on the first batch, and
wherein the method comprises performing a second operation for the first batch and a first operation for the second batch together.

17. A memory device configured to perform neural network learning, the memory device comprising:
a memory comprising a plurality of dedicated memory regions corresponding to a plurality of links included in a neural network, respectively; and
a processor configured to perform an operation to train the neural network,
wherein the plurality of dedicated memory regions are configured to store a plurality of weights for corresponding links, respectively,
wherein the plurality of dedicated memory regions are logically separated from one another, and
wherein the processor is further configured to
perform the operation based on at least one of a plurality of weights respectively stored in the plurality of dedicated memory regions, and
delete a weight used in the operation from the plurality of dedicated memory regions.

18. The memory device of claim 17, wherein a number of the plurality of dedicated memory regions is greater than or equal to a number of the plurality of links included in the neural network.

19. The memory device of claim 17,
wherein the neural network comprises N hidden layers, wherein N is an integer greater than or equal to 1, and
wherein a number of plurality of weights stored in each of the plurality of dedicated memory regions is 2×N or greater.

20. The memory device of claim 17, wherein the processor is further configured to determine a plurality of final weights corresponding to each of the plurality of links, based on a combination of the plurality of weights respectively stored in the plurality of dedicated memory regions after training of the neural network is completed.
